(19) United States
(12) Patent Application Publication
(10) Pub. No.: US 2026/0353148 A1
(43) Pub. Date: Nov. 5, 2026

(54) METHODS AND COMMUNICATIONS DEVICES FOR A WIRELESS COMMUNICATIONS NETWORK

(71) Applicant: Sony Group Corporation, Tokyo (JP)

(72) Inventors: Yuxin WEI, Basingstoke (GB); Vivek SHARMA, Basingstoke (GB); Yassin Aden AWAD, Basingstoke (GB)

(73) Assignee: Sony Group Corporation, Tokyo (JP)

(21) Appl. No.: 19/488,176

(22) PCT Filed: Jul. 3, 2024
(86) PCT No.: PCT/EP2024/068769

§ 371 Date: Nov. 26, 2025

(30) Foreign Application Priority Data
Jul. 6, 2023 (EP) 23183925.9

(51) Int. Cl. H04W 24/10; H04L 41/5003

(52) U.S. Cl. CPC H04W 24/10; H04L 41/5003

(57) ABSTRACT

Methods, communications devices, and circuitry having one or more peer communications devices. A communications device measures a quality of a direct radio link to an infrastructure equipment of a wireless communications network, and a quality of a direct radio link to a peer communications device. The communications device transmits a sidelink measurement report to a peer communications device, where the sidelink measurement report includes an indication of the quality of both the measured links.

The present application claims the Paris Convention priority of European patent application EP 23183925.9, filed 6 Jul. 2023, the contents of which are hereby incorporated by reference.

### BACKGROUND

### Field of Disclosure

The present disclosure relates to communications device and methods of operating communications devices for inter-communications device communications.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Modern mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Wireless communications networks are expected to routinely and efficiently support communications with an ever-increasing range of devices associated with a wide range of data traffic profiles and types. For example, it is expected that wireless communications networks efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is a desire for current generation wireless communications networks, for example those referred to as 5G or new radio (NR) systems/new radio access technology (RAT) systems, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is enhanced Mobile Broadband (eMBB) services, which are characterised by a high capacity with a requirement to support up to 20 Gb/s. URLLC and eMBB type services therefore represent challenging examples for both LTE type communications systems and 5G/NR communications systems.

5G NR has continuously evolved and the current work plan includes 5G-NR-advanced in which some further enhancements are expected, especially to support new use-cases/scenarios with higher requirements. The desire to support these new use-cases and scenarios gives rise to new challenges for efficiently handling communications in wireless communications systems that need to be addressed.

### SUMMARY OF THE DISCLOSURE

The present disclosure can help address or mitigate at least some of the issues discussed above.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 illustrates an example implementation of a multipath arrangement for a UE connected to a gNB via a direct path and a sidelink path via a relay UE.

FIG. 5 illustrates an example arrangement of multiple UEs having sidelink connections in an example teaching of the present disclosure.

FIG. 6 illustrates an example arrangement of multiple UEs having sidelink connections and that are provided with connectivity to multiple networks according to an example of the present disclosure.

FIG. 7 illustrates an example method for a first communications device according to an example of the present disclosure.

FIG. 8 illustrates an example method for a second communications device according to an example of the present disclosure.

### DETAILED DESCRIPTION OF THE EMBODIMENTS

### Long Term Evolution Advanced Radio Access Technology (4G)

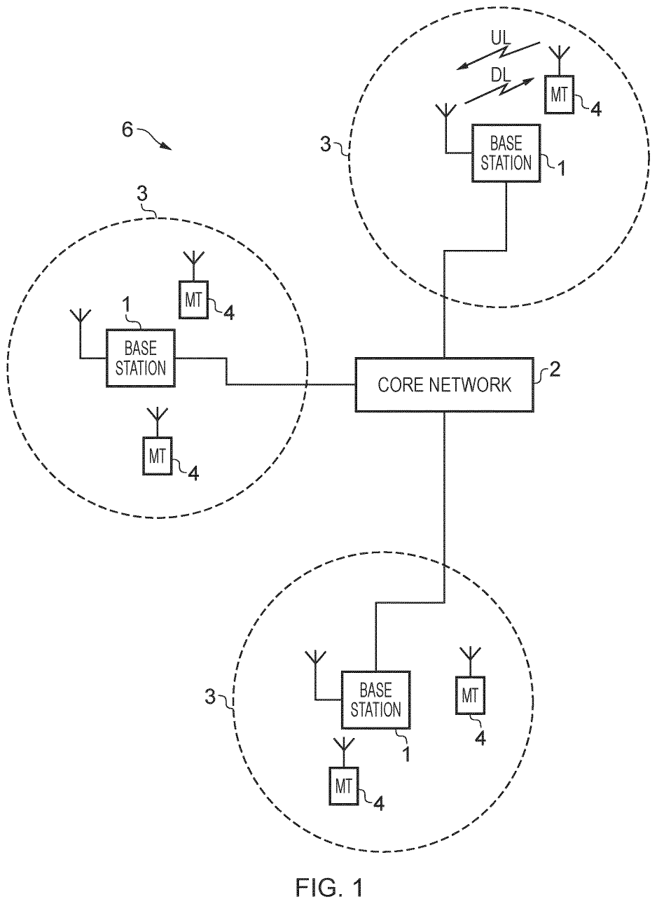

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices or mobile terminals (MT) 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. The communications or terminal devices 4 may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G (NR))

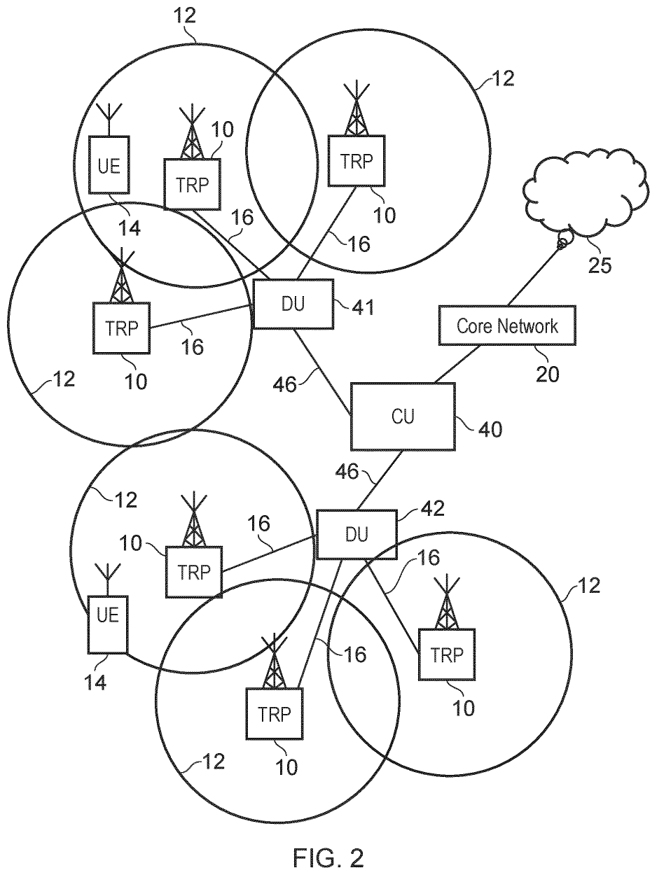

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 25.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

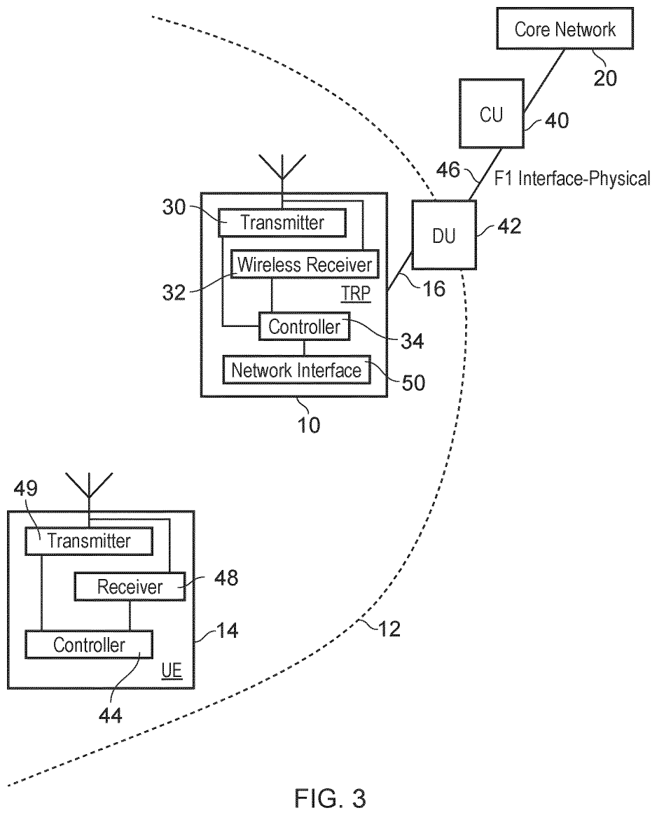

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter circuit 49, a receiver circuit 48 and a controller circuit 44 which is configured to control the transmitter circuit 49 and the receiver circuit 48 to transmit signals representing uplink data to the wireless communications network via the wireless access interface formed by the TRP 10 and to receive downlink data as signals transmitted by the transmitter circuit 30 and received by the receiver circuit 48 in accordance with the conventional operation.

The transmitter circuits 30, 49 and the receiver circuits 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controller circuits 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP10 to the DU 42 and the F1 interface 46 from the DU 42 to the CU 40.

### Sidelink Connection

Some existing network implementations provide for sidelink connections between UEs. A sidelink connection is a direct communication link established between two or more User Equipment (UE) devices without going through a cellular network. Sidelink communication can be used in various applications, such as vehicle-to-vehicle (V2V) communication, device-to-device (D2D) communication, and machine-type communications (MTC). The sidelink communication enables UEs to exchange data directly without relying on a centralized infrastructure, thereby improving communication efficiency and reducing latency. Such sidelink may be used, for example, to extend network coverage to remote UEs, or to provide a remote UE with a multipath connection to the network.

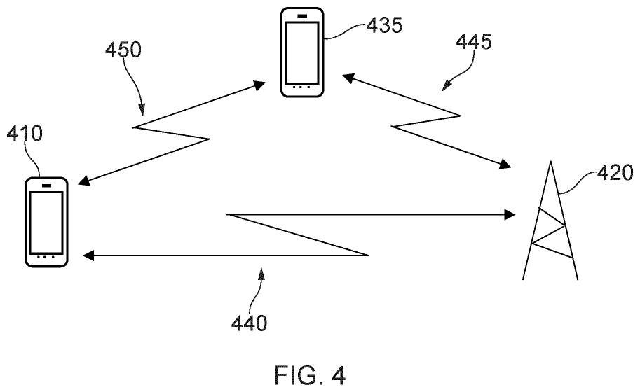

FIG. 4 shows a first example implementation of a multipath connection using a sidelink relay. In FIG. 4, a UE 410 is connected to a gNB 420 via a Uu link 440, which is a direct radio interface between a UE and a gNB (or other infrastructure equipment or base station, such as those described in relation to FIGS. 1-3), and may exchange uplink (UL) and/or downlink (DL) traffic with the gNB 420 via the Uu link 440. In addition, the gNB 420 is also connected to a Layer-2 UE-to-network relay UE 435 via a Uu link 445, and the UE 410 is connected to the relay UE 435 via a sidelink 450 (e.g. a PC5 link, Wi-Fi link, or Bluetooth link), which is a direct radio interface between a UE and another UE or relay node. In this manner, the UE 410 may additionally exchange UL and/or DL traffic with the gNB 420 via the sidelink 450 and Uu link 445, collectively known as an indirect connection between the UE 410 and the gNB 420. As such, the UE 410 may exchange traffic with the same gNB 420 using multiple different links/connections: a direct link and an indirect link. FIG. 4B shows an alternative example implementation of multipath using a sidelink relay. The relay UE 435 may in some cases be similar to UE 410, and as such the UE-to-UE connection 450 between the UE 410 and the relay UE 435 may utilise a number of possible communication protocols, such as 4G/NR/5G (as discussed in relation to FIGS. 1-3, or other, non-3GPP protocols such as Bluetooth or Wi-Fi). The techniques of the present disclosure may be generally considered to be applicable to the arrangements in FIG. 4, unless otherwise stated.

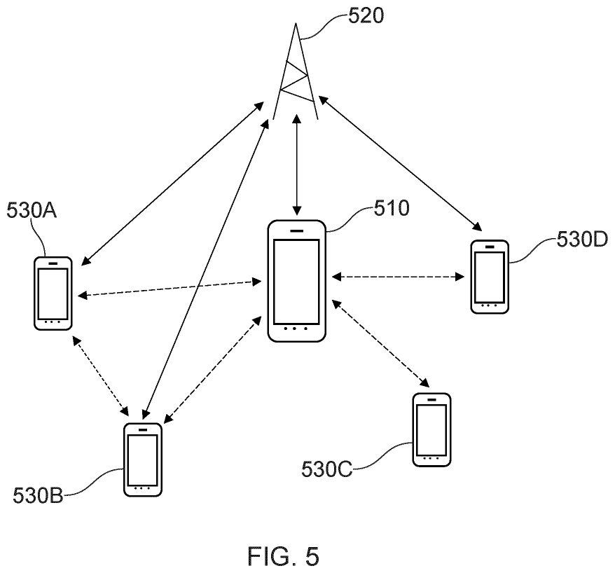

While FIG. 4 illustrates the use of a sidelink in the context of multipath connections, FIG. 5 shows an example implementation of a number of different sidelink connections for different devices. This arrangement includes a plurality of UEs 530A-D, where UEs 530A, 530B, and 530D have a direct connection to a base station 520 (which may e.g. be Uu connections). In addition, UEs 530A and 530B have a direct UE-to-UE connection between one another (which may e.g. be a PC5 connection or other suitable sidelink connection type) which serves as a sidelink connection. Furthermore, the arrangement of FIG. 5 includes a master node 510 having a direct radio connection to the base station 520 and a direct radio connection to each of the UEs 530A-D (i.e. UEs 530A-D and master node 510 are peer UEs with one another). Here, UEs 530A-D may communicate with the network 520 via the master node 510, using the sidelink connections to the master node 510. The master node 510 may be a communications device such as those described in relation to any of FIGS. 1-3.

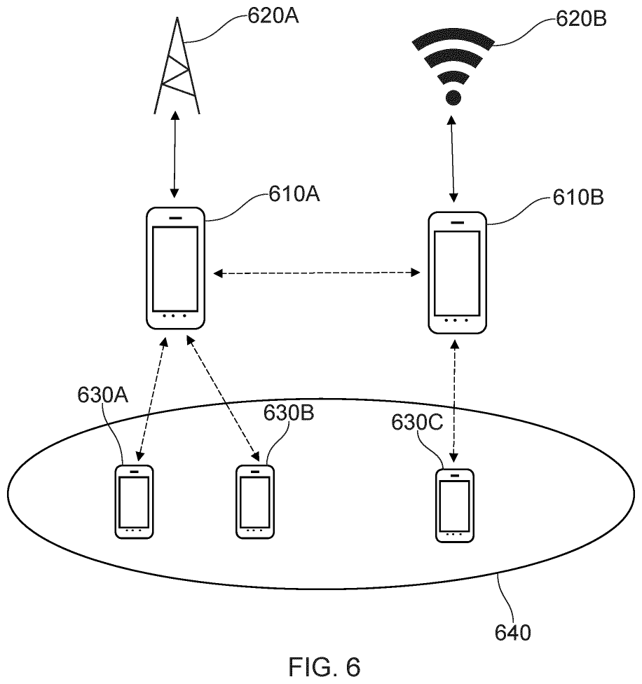

FIG. 6 illustrates an example of a further implementation which utilises sidelink connections between UEs. Here, a number of UEs 630A-C may be located within a particular geographic location 640 (e.g. a single household), and may have sidelink connections to master nodes 610A-610B, as indicated by the dashed arrows in FIG. 6, in a similar manner to that described above in relation to FIG. 5. Furthermore, master nodes 610A-B may have a sidelink connection with one another. The master nodes 610A-B may in some cases have a connection to different networks 610A-B. For example, master node 610A may have a connection to a first network 620A being a radio access network operated by a first provider, while master node 620B may, for example, have a connection to a second network 620B, which may be different to the radio access network operated by the first provider. For example, the second network 620B may be a radio access network operated by a second provider different to the first provider, or the second network 620B may utilise a different wireless access technology (such as Wi-Fi).

This arrangement including multiple master nodes 610 may allow the UEs 630 in the same location 640 to access both the first network 620A and second network 620B. For example, UE 630A may access the first network 620A via the UEs 630A sidelink connection to the main node 610A and via the main node's 610A connection to the first network 620A. The UE 630A may also access the second network 620B via the UEs 630A sidelink connection to the main node 610A, the main node's 610A sidelink connection to the other main node 610B, and the main node's 610B connection to the second network 620B. In the same way, UEs 630B and 630C may access both the first and second networks, 620A-B. The main nodes 610A-B may be communications devices such as those described in relation to any of FIGS. 1-3, or in some cases may be a reconfigurable intelligent surface (RIS).

In some arrangements, such as those shown in FIGS. 5 and 6, it may be desirable to change the master node to be a different UE (e.g. to select one of UEs 530A-D as the master node in the example of FIG. 5). For example, the master node should be a UE that has a strong direct radio connection to the base station and which has strong UE-to-UE connections. However, it can be challenging for UEs to collect and distribute this information in a manner allows for informed decisions to be made regarding the selection of the master node.

For example, some approaches for managing connections between various devices allow a UE to transmit a measurement report to the network (e.g. in the form of a MeasurementReport message). That is, a UE may measure a quality (e.g. an RSSI or RSRP value or RSRQ value) of its own connection to the network, and may then inform the network of the results. In some cases, the measurement report sent to the network by the UE may also include an indication of a quality of a sidelink connection that UE has to another UE. In a similar manner, a UE may measure a quality (e.g. an RSSI or RSRP value) of the UE's existing sidelink connection to another UE, and may then inform the other UE of the results in a sidelink measurement report (e.g. in the form of a MeasurementReportSidelink message) using the sidelink connection.

However, while the network may be informed of the quality of a UE's connection to the network, and both the network and UEs may be informed about the quality of a sidelink connection between UEs, a given UE is unaware of the quality of other UEs' connections to the network. As such, a group of UEs, such as those in FIGS. 5 and 6 are unable to make informed decisions regarding which UE should be selected as a master UE, or other decisions regarding the nature and uses of the sidelink connections and direct connections to the network, without intervention from the network.

According to the teachings of the present disclosure, a communications device (e.g. a UE) performs a first measurement of a quality of a first connection, the first connection being a direct radio connection between the first communications device and an infrastructure equipment of wireless communications network. The communications device additionally performs a second measurement of a quality of a second connection, the second connection being a direct radio connection between the first communications device and the second communications device. The communications device then transmits, to a second communications device with which the communications device has an existing sidelink connection, a measurement report, wherein the measurement report includes an indication of the quality of the first connection and an indication of the quality of the second connection. In this manner, a first UE may inform a second UE of the quality of both sidelink connections and connections with the network.

As such, UEs are made more aware of the quality of neighbouring UEs' connections to the network. Accordingly, the UEs may make more informed decision regarding the routing of traffic between UEs and the network. For example, UEs (as opposed to the network) may determine that traffic for the network should be routed via particular UE, based on the results of the measurements, and/or may determine a grouping of the UEs.

Returning to the example of FIG. 5, one or multiple UEs 530A-D may transmit the measurement report to the master node 510 and/or another one of the UEs 530A-D. Likewise, the master node 510 may transmit the measurement report to one or more of the UEs 530A-D. As such, one or more of the UEs 530-D or master node 510 may instigate a change in the master node 510, such that traffic for the UEs to the network 520 is routed via a different UE. Likewise, this information may be used by the UEs to alter one or more sidelink connections between the UEs 530A-D, and/or to group particular UEs to use a particular master node.

In addition to the indication of the quality of the sidelink connection and the indication of the quality of the direct connection to the network, the measurement report may include additional information. For example, the measurement report may include an identifier of a serving cell for the UE sending the measurement report. This can be used by the receiving UE to identify whether the receiving UE and the sending UE are in the same serving cell. In some cases, UEs belonging to the same serving cell may be grouped together (i.e., may be assigned the same master node), and UEs having different serving cells may not be allowed to form a group or cluster.

In some cases, it may not be desirable for a UE to always include the indication of the quality of the UEs connection to the network (the UE's Uu connection) in the measurement report. That is, in some cases it may be preferable for the UE to only send the indication of the quality of the UE's sidelink measurement. As such, a UE may be provided with an indication of whether it should include the measurement of the quality of its direct connection to the network within the measurement report. Based on the received indication, the UE may selectively include the measurement of the quality of its direct connection to the network within the measurement report. In some cases, the UE may default to not including the measurement of the quality of its direct connection to the network within the measurement report and may only include said measurement if explicitly instructed to do so, however in other implementations the opposite may be true. Furthermore, the indication of whether the UE should include the measurement of the quality of its direct connection to the network within the measurement report may be received directly from the network (i.e., via the UE's Uu connection), or via the UE's UE-to-UE connection (e.g., via the UE's PC5 connection) from a different UE.

The transmission of the measurement report may usually be triggered by the measured quality of UE's sidelink connection moving above or below a predetermined threshold. However, the transmission of the measurement report may be triggered in a number of different ways. For example, for a given UE, a peer UE (a UE with a sidelink connection to the given UE) or the network may transmit an explicit trigger to the peer UE. This may be used, for example, in cases where the network or a group of UEs want to trigger a particular procedure, such as master node (re)selection, or a procedure which is not dependent on UE-to-UE link quality. This explicit trigger may be transmitted to the UE using dedicated signalling e.g., using RRC signalling from the network or signalling from a peer UE. Alternatively, the explicit trigger may be transmitted to the UE using broadcast signalling. For example, the network may broadcast the explicit trigger to the UE, and as such UEs may transmit the measurement report to their respective peer UEs. The UEs may each generate a randomized time window in which to transmit the measurement report to avoid overloading the system at a particular time. The UEs may be instructed to use such a randomized time window by the communication including the explicit trigger.

In other examples, rather than transmitting an explicit trigger to transmit the measurement report, the network or a peer UE may transmit to a given UE a conditional trigger to transmit the measurement report. For example, the conditional trigger may be configured for only some UEs to transmit the measurement report. One example is that the trigger may be configured to cause only master UEs, only relay UEs, only remote UEs, or a particular group of UEs to transmit the measurement report. Such a trigger may be transmitted to a given UE using dedicated signalling or using broadcast signalling. One example is that the trigger may be included in a system information broadcast (SIB) within a cell, such that the trigger may be applicable for all UEs connected in the cell having a sidelink connection.

Additionally or alternatively, the conditional trigger may cause a UE to transmit the measurement report based on one or more conditions. For example, the conditions may include the quality of the UE's direct radio connection to the network (the UE's Uu connection) falling below a particular threshold. A master UE, such as those shown and discussed in relation to FIGS. 5 and 6, require strong Uu connections, and as such the degradation of a master UE's Uu connection may mean that a new master UE is required. Additionally or alternatively, the one or more conditions may include the passage of particular time period (e.g. since the measurement report was last sent, or the time measured at time is beyond a duration threshold). This ensures that a UE's Uu connection quality is periodically checked to ensure that a UE is still (or is still not) the most suitable UE to act as a master UE. Additionally or alternatively, the one or more conditions may include the particular location of the UE. For example, the UE may be required to transmit the measurement report if the UE moves outside of a particular location or region. As such, a UE's suitability to act as a master UE, or a UE's grouping within a particular group of UEs, may be checked when significant changes that may affect the connectivity of the UE occur.

In some cases, a Layer 1 sidelink measurement and a Uu link quality may be exchanged in the measurement report via PC5 Layer 1 signalling. This may be used, for example, for a Layer 1-based sidelink link switch. Here, the network, or a master UE, relay UE, or peer UE may configure the measurement, and the link switch may be based on lower layer signalling, such as MAC or Layer 1 signalling. The use of Layer 1 signalling in this way may also be used for master UE selection, as described above.

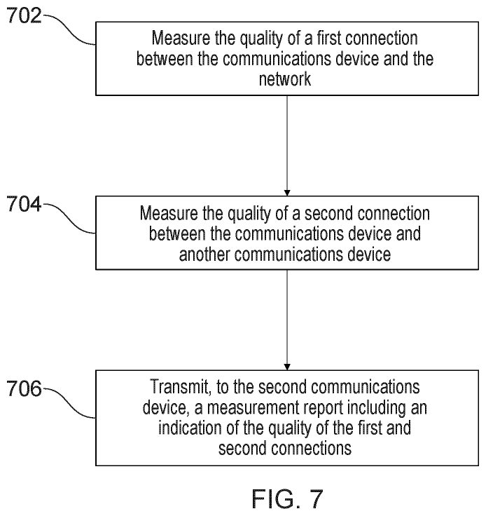

FIG. 7 illustrates an example method for a first communications device according to the present disclosure. The method includes step 702 of performing a first measurement of a quality of a first link, the first link being a direct radio link between the first communications device and the infrastructure equipment. It should be noted that the first measurement may be a measurement of a serving cell of the communications device (i.e., the first infrastructure equipment is the infrastructure equipment through which the communications device is connected to the network). In other examples, the first measurement may not measure a serving cell, such that the communications device may not have an established connection to the first infrastructure equipment.

The method additionally includes the step 704 of performing a second measurement of a quality of a second link, the second link being a direct radio link between the first communications device and the second communications device. It should be noted that steps 702 and 704 may be performed in any order. The method further includes step 706 of transmitting, to the second communications device, a measurement report, wherein the measurement report includes an indication of the quality of the first link and an indication of the quality of the second link.

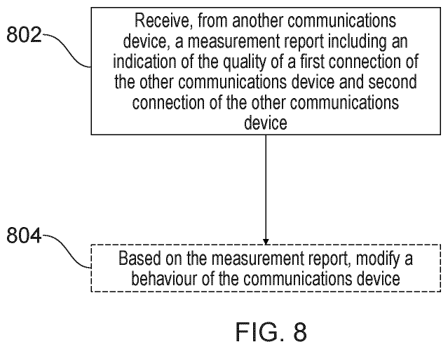

FIG. 8 illustrates an example method for a communications device. At step 802, the communications device receives, from another communications device, a measurement report including an indication of the quality of a first link of the other communications device and second link of the other communications device. The first link is a direct radio link between the other communications device and the network. The second link is a direct radio link between the other communications device and one or more peer devices of the other communications device. In other words, the measurement report may include a quality indication of some or all of the other communications device's UE-to-UE links, as well as its Uu link. Optionally, the method includes the step 804 of modifying the behaviour of the communications device based on the received measurement report. For example, the communications device may connect to a new peer UE, break its connection to a peer UE, connect to a new relay UE, break its connection to a relay UE, connect to a new master UE, or begin to act as a master UE for its peer UEs. In other words, the communications device may modify its routing behaviour in substantially any way based on receiving the measurement report including the indications of the quality of the first and second link.

Thus, from one perspective, there has now been described methods, communications devices, and circuitry having one or more peer communications devices. A communications device measures a quality of a direct radio link to an infrastructure equipment of a wireless communications network, and a quality of a direct radio link to a peer communications device. The communications device transmits a sidelink measurement report to a peer communications device, where the sidelink measurement report includes an indication of the quality of both the measured links.

Further examples of feature combinations taught by the present disclosure are set out in the following numbered clauses:
1. A method of operating a first communications device configured to transmit signals to and/or to receive signals from one or more infrastructure equipment of a wireless communications network via a wireless radio interface provided by the wireless communications network, and to transmit signals to and/or to receive signals from one or more peer communications devices, the method comprising: performing a first measurement of a quality of a first link, the first link being a direct radio link between the first communications device and a first infrastructure equipment of the one or more infrastructure equipment; performing a second measurement of a quality of one or more second links, the one or more second links being direct radio links between the first communications device and the one or more peer communications devices; and transmitting, to the one or more peer communications devices, a measurement report, wherein the measurement report includes an indication of the quality of the first link and an indication of the quality of the one or more second links.
2. The method according to clause 1, wherein the measurement report additionally includes a serving cell identifier for the first communications device.
3. The method according to clause 1 or clause 2, further comprising: receiving an indication that the quality of the first link should be included in the measurement report.
4. The method according to clause 3, wherein the indication that the quality of the first link should be included in the measurement report is received from the infrastructure equipment.
5. The method according to clause 3, wherein the indication that the quality of the first link should be included in the measurement report is received from the one or more peer communications devices.
6. The method according to any preceding clause, further comprising: determining that the measurement report should be transmitted to the one or more peer communications devices.
7. The method according to clause 6, wherein the first communications device determines that the measurement report should be transmitted to the one or more peer communications devices based on the quality of the first link falling below a predefined threshold.
8. The method according to clause 6 or clause 7, wherein the first communications device determines that the measurement report should be transmitted to the one or more peer communications devices based on a received trigger.
9. The method according to clause 8, wherein the first communications device receives the trigger from the infrastructure equipment.
10. The method according to clause 9, wherein the trigger is received in a broadcast transmission from the infrastructure equipment.
11. The method according to clause 9, wherein the first communications device receives the trigger from the one or more peer communications devices.
12. The method according to any of clauses 8, 10, and 11, wherein the trigger is received in dedicated signalling from the infrastructure equipment or the one or more peer communications devices.
13. The method according to any of clauses 8-12, wherein the trigger is an explicit instruction for the first communications device to transmit the measurement report.
14. The method according to clause 13, wherein the first communications device determines a randomised time window in which to transmit the measurement report.
15. The method according to any of clauses 8-14, wherein the trigger is a conditional trigger.
16. The method according to clause 15, wherein the conditional trigger includes the quality of the first link falling below a predefined threshold.
17. The method according to clause 15 or clause 16, wherein the conditional trigger includes a particular time period or time duration elapsing.
18. The method according to any of clauses 15-17, wherein the conditional trigger includes a change in location of the first communications device.
19. The method according to any preceding clause, wherein the first communications device is a master node having direct radio connections to a plurality of communications devices.
20. The method according to any preceding clause, wherein the one or more peer communications devices has a direct radio connection to an infrastructure equipment of the wireless communications network.
21. The method according to any preceding clause, wherein a particular one of the one or more peer communications devices is a master node having direct radio connections to a plurality of communications devices.
22. The method according to any preceding clause, wherein the first link is a Uu link, and wherein the one or more second links are PC5 links.
23. The method according to any preceding clause, wherein performing the measurement of the quality of the first and/or one or more second links comprise measuring an received signal strength indicator (RSSI), reference signal received power (RSRP), or reference signal received quality (RSRQ) value for the first and/or one or more second links.
24. The method according to any preceding clause, wherein the first infrastructure equipment provides a serving cell to which the communications device is connected.
25. The method according to any of clauses 1-23, wherein the first infrastructure equipment provides a neighbouring cell.
26. A communications device comprising: a transceiver configured to transmit signals to and/or to receive signals from one or more infrastructure equipment of a wireless communications network via a wireless radio interface provided by the wireless communications network, and to transmit signals to and/or to receive signals from one or more peer communications devices, and a controller configured in combination with the transceiver to: perform a first measurement of a quality of a first link, the first link being a direct radio link between the first communications device and a first infrastructure equipment of the one or more infrastructure equipment; perform a second measurement of a quality of one or more second links, the one or more second links being direct radio links between the first communications device and the one or more peer communications devices; and transmit, to the one or more peer communications devices, a measurement report, wherein the measurement report includes an indication of the quality of the first link and an indication of the quality of the one or more second links.
27. Circuitry for a communications device, the circuitry comprising: transceiver circuitry configured to transmit signals to and/or to receive signals from one or more infrastructure equipment of a wireless communications network via a wireless radio interface provided by the wireless communications network, and to transmit signals to and/or to receive signals from one or more peer communications devices, and controller circuitry configured in combination with the transceiver circuitry to: perform a first measurement of a quality of a first link, the first link being a direct radio link between the first communications device and a first infrastructure equipment of the one or more infrastructure equipment; perform a second measurement of a quality of one or more second links, the one or more second links being direct radio links between the first communications device and the one or more peer communications devices; and transmit, to the one or more peer communications devices, a measurement report, wherein the measurement report includes an indication of the quality of the first link and an indication of the quality of the one or more second links.
28. A method of operating a communications device configured to transmit signals to and/or to receive signals from one or more first peer communications devices of a wireless communications network, the method comprising: receiving, from a first communications device of the one or more peer communications devices, a measurement report, wherein the measurement report includes an indication of a quality of a first link and an indication of a quality of one or more second links, wherein the first link is a direct radio link between the first communications device and a first infrastructure equipment of the wireless communications network, and wherein the one or more second links are direct radio links between the first communications device and one or more second peer communications devices.
29. The method according to clause 28, wherein the measurement report additionally includes a serving cell identifier for the first communications device.
30. The method according to clause 28 or clause 29, further comprising: transmitting, to the first communications device, an indication that the quality of the first link should be included in the measurement report.
31. The method according to any of clauses 8-30, further comprising: transmitting, to the first communications device, a trigger for the first communications device to transmit the measurement report.
32. The method according to clause 31, wherein the trigger is an explicit instruction for the first communications device to transmit the measurement report.
33. The method according to any of clauses 31-32, wherein the trigger is a conditional trigger.
34. The method according to clause 33, wherein the conditional trigger includes the quality of the first link falling below a predefined threshold.
35. The method according to clause 33 or clause 34, wherein the conditional trigger includes a particular time period or time duration elapsing.
36. The method according to any of clauses 33-35, wherein the conditional trigger includes a change in location of the first communications device.
37. The method according to any of clauses 28-36, wherein the first communications device is a master node having direct radio connections to a plurality of communications devices.
38. The method according to any of clauses 28-37, wherein the communications device has a direct radio connection to an infrastructure equipment of the wireless communications network.
39. The method according to any of clauses 28-38, wherein the first link is a Uu link, and wherein the one or more second links are PC5 links.
40. The method according to any of clauses 28-39, wherein performing the measurement of the quality of the first and/or one or more second links comprise measuring an received signal strength indicator (RSSI), reference signal received power (RSRP), or reference signal received quality (RSRQ) value for the first and/or one or more second links.
41. The method according to any of clauses 28-40, wherein the first infrastructure equipment provides a serving cell to which the communications device is connected.
42. The method according to any of clauses 28-41, wherein the first infrastructure equipment provides a neighbouring cell.
43. The method according to any of clauses 28-42, further comprising: receiving, from a second communications device of the peer communications devices, another measurement report, wherein the other measurement report includes an indication of a quality of a third link and an indication of a quality of one or more fourth links, wherein the third link is a direct radio link between the second communications device and a second infrastructure equipment of the wireless communications network, and wherein the one or more fourth links are direct radio links between the second communications device and one or more third peer communications devices.
44. The method according to clause 43, wherein the first infrastructure equipment and the second infrastructure equipment are the same infrastructure equipment.
45. A communications device comprising: a transceiver configured to transmit signals to and/or to receive signals from one or more first peer communications devices of a wireless communications network, and a controller configured in combination with the transceiver to: receive, from a first communications device of the one or more peer communications devices, a measurement report, wherein the measurement report includes an indication of a quality of a first link and an indication of a quality of one or more second links, wherein the first link is a direct radio link between the first communications device and a first infrastructure equipment of the wireless communications network, and wherein the one or more second links are direct radio links between the first communications device and one or more second peer communications devices.
46. Circuitry for a communications device, the circuitry comprising: transceiver circuitry configured to transmit signals to and/or to receive signals from one or more first peer communications devices of a wireless communications network, and controller circuitry configured in combination with the transceiver circuitry to: receive, from a first communications device of the one or more peer communications devices, a measurement report, wherein the measurement report includes an indication of a quality of a first link and an indication of a quality of one or more second links, wherein the first link is a direct radio link between the first communications device and a first infrastructure equipment of the wireless communications network, and wherein the one or more second links are direct radio links between the first communications device and one or more second peer communications devices.

### REFERENCES

Holma H. and Toskala A, “LTE for UMTS OFDMA and SC-FDMA based radio access”, John Wiley and Sons, 2009.

1. A method of operating a first communications device configured to transmit signals to and/or to receive signals from one or more infrastructure equipment of a wireless communications network via a wireless radio interface provided by the wireless communications network, and to transmit signals to and/or to receive signals from one or more peer communications devices, the method comprising:
performing a first measurement of a quality of a first link, the first link being a direct radio link between the first communications device and a first infrastructure equipment of the one or more infrastructure equipment;
performing a second measurement of a quality of one or more second links, the one or more second links being direct radio links between the first communications device and the one or more peer communications devices; and
transmitting, to the one or more peer communications devices, a measurement report, wherein the measurement report includes an indication of the quality of the first link and an indication of the quality of the one or more second links.

2. The method according to claim 1, wherein the measurement report additionally includes a serving cell identifier for the first communications device.

3. The method according to claim 1, further comprising:
receiving an indication that the quality of the first link should be included in the measurement report.

4. The method according to claim 3, wherein the indication that the quality of the first link should be included in the measurement report is received from the infrastructure equipment.

5. The method according to claim 3, wherein the indication that the quality of the first link should be included in the measurement report is received from the one or more peer communications devices.

6. The method according to claim 1, further comprising:
determining that the measurement report should be transmitted to the one or more peer communications devices.

7. The method according to claim 6, wherein the first communications device determines that the measurement report should be transmitted to the one or more peer communications devices based on the quality of the first link falling below a predefined threshold.

8. The method according to claim 6, wherein the first communications device determines that the measurement report should be transmitted to the one or more peer communications devices based on a received trigger.

9. The method according to claim 8, wherein the first communications device receives the trigger from the infrastructure equipment.

10. The method according to claim 9, wherein the trigger is received in a broadcast transmission from the infrastructure equipment.

11. The method according to claim 9, wherein the first communications device receives the trigger from the one or more peer communications devices.

12. The method according to claim 8, wherein the trigger is received in dedicated signalling from the infrastructure equipment or the one or more peer communications devices.

13. The method according to claim 8, wherein the trigger is an explicit instruction for the first communications device to transmit the measurement report.

14. The method according to claim 13, wherein the first communications device determines a randomised time window in which to transmit the measurement report.

15. The method according to claim 8, wherein the trigger is a conditional trigger.

16. The method according to claim 15, wherein the conditional trigger includes the quality of the first link falling below a predefined threshold.

17. The method according to claim 15, wherein the conditional trigger includes a particular time period or time duration elapsing.

18. The method according to claim 15, wherein the conditional trigger includes a change in location of the first communications device.

19.-25. (canceled)

26. A communications device comprising:
a transceiver configured to transmit signals to and/or to receive signals from one or more infrastructure equipment of a wireless communications network via a wireless radio interface provided by the wireless communications network, and to transmit signals to and/or to receive signals from one or more peer communications devices, and
a controller configured in combination with the transceiver to:
perform a first measurement of a quality of a first link, the first link being a direct radio link between the first communications device and a first infrastructure equipment of the one or more infrastructure equipment;
perform a second measurement of a quality of one or more second links, the one or more second links being direct radio links between the first communications device and the one or more peer communications devices; and
transmit, to the one or more peer communications devices, a measurement report, wherein the measurement report includes an indication of the quality of the first link and an indication of the quality of the one or more second links.

27.-44. (canceled)

45. A communications device comprising:
a transceiver configured to transmit signals to and/or to receive signals from one or more first peer communications devices of a wireless communications network, and
a controller configured in combination with the transceiver to:
receive, from a first communications device of the one or more peer communications devices, a measurement report, wherein the measurement report includes an indication of a quality of a first link and an indication of a quality of one or more second links, wherein the first link is a direct radio link between the first communications device and a first infrastructure equipment of the wireless communications network, and wherein the one or more second links are direct radio links between the first communications device and one or more second peer communications devices.

46. (canceled)
